(19) United States
(12) Patent Application Publication
(10) Pub. No.: US 2016/0189201 A1
(43) Pub. Date: Jun. 30, 2016

(54) ENHANCED TARGETED ADVERTISING SYSTEM

(71) Applicant: Yahoo! Inc., Sunnyvale, CA (US)

(72) Inventor: Xuhui Shao, Palo Alto, CA (US)

(73) Assignee: YAHOO! INC., Sunnyvale, CA (US)

(21) Appl. No.: 14/583,457

(22) Filed: Dec. 26, 2014

(51) Int. Cl. G06Q 30/02

(52) U.S. Cl. CPC G06Q 30/0243; G06Q 30/0254; G06Q 30/0277

(57) ABSTRACT

Described herein are example systems and operations for enhancing targeted advertising using A/B testing. These examples provide solutions to problems in targeted advertising, such as the problem of not being able to identify audience and/or situational targets mostly or only influenced by the ad or ad campaign of concern. For example, described herein are solutions that can build a pair of differential behavioral data sets similar to an A/B clinical study. Then two or more models can be generated on each data set. In an example, these models can be based on machine learning and/or statistical analysis. The differential learning between the two or more models can then be used to enhance predictions of desired response probabilities mostly or only due to the influence of the ad or ad campaign being modeled.

### BACKGROUND

This application relates to enhanced targeted advertising using A/B tests.

Increasingly, advertising is being integrated with online content. Online audiences are demanding free content or at least content delivered at below market prices. Because of this demand, publishers and content networks may be delivering ads with such content to compensate for lost profits. It has also been found that advertising can be acceptable to online audiences if the advertising is useful to audience members. Also, beyond being acceptable, advertising can be sought after by users if it is well targeted.

In the online ad industry, predictive models for desired online response prediction can be built by collecting positive and negative outcomes based on observational data. Such models can predict the probability of desired responses with specific combinations of ads, sites, user attributes and other transactional and/or contextual variables. The models, however, ignore influence of the ads themselves on their own desired responses. For example, these models do not account for users that will convert regardless of the ad or ad campaign under study. Also, these models do not provide which users will convert mostly or only because of the ad or ad campaign under study. Also, these models do not provide which situations will lead to a desired response mostly or only due to the combination of the situations and the ad or ad campaign under study.

A/B testing has been a known technique for enhancing predictive models, but known forms of A/B testing have not been known to resolve the aforementioned problems. There is, therefore, a set of engineering problems to be solved in order to provide enhanced targeted advertising using A/B testing that provides predictive models that can predict which users will respond and/or situations that will lead to a desired response mostly or only because of the ad or ad campaign under study. In other words, there is a set of technical problems to be solved in order to provide enhanced targeted advertising using A/B testing that provides a target for targeted advertising that will respond and/or lead to a desired response where it is certain that the largest influence in the desired response is the ad or ad campaign under study.

Resolution of such engineering problems is pertinent considering the competitive landscape of online advertising. The resolution of these technical issues can benefit advertisers in providing more effective and efficient use of ad impressions and targeted advertising, which may result in a greater number of user interactions with their ads. The novel technologies described herein also set out to solve a set of technical problems caused by the scope of online targeted advertising. Today, there is room for improvement for resolving the aforementioned problems in online advertising.

### BRIEF DESCRIPTION OF THE DRAWINGS

The systems and methods may be better understood with reference to the following drawings and description. Non-limiting and non-exhaustive examples are described with reference to the following drawings. The components in the drawings are not necessarily to scale; emphasis instead is being placed upon illustrating the principles of the system. In the drawings, like referenced numerals designate corresponding parts throughout the different views.

FIG. 1 illustrates a block diagram of an example information system 100 that includes example devices of a network that can communicatively couple with an example system that can provide enhanced targeted advertising using A/B tests.

FIG. 2 illustrates displayed ad items and content items of example screens rendered by client-side applications. Some of the displayed items may be provided through advertising channels that feature enhanced targeted advertising using A/B tests.

FIG. 3 illustrates a block diagram of example aspects of a system that can provide enhanced targeted advertising using A/B tests, such as the system in FIG. 1.

FIG. 4 illustrates example operations performed by a system, such as the systems in FIGS. 1 and 3.

FIGS. 5 and 6 illustrate block diagrams of example devices of a system that can provide enhanced targeted advertising using A/B tests, such as the systems in FIGS. 1 and 3.

### DETAILED DESCRIPTION

Subject matter will now be described more fully hereinafter with reference to the accompanying drawings, which form a part hereof, and which show, by way of illustration, specific examples. Subject matter may, however, be embodied in a variety of different forms and, therefore, covered or claimed subject matter is intended to be construed as not being limited to examples set forth herein; examples are provided merely to be illustrative. Likewise, a reasonably broad scope for claimed or covered subject matter is intended. Among other things, for example, subject matter may be embodied as methods, devices, components, or systems. The following detailed description is, therefore, not intended to be limiting on the scope of what is claimed.

Aspects of systems and operations, described herein, labeled as “first”, “second”, “third”, and so on, should not necessarily be interpreted to have chronological associations with each other. In other words, such labels are used to merely distinguish aspects of the systems and operations described herein, unless the context of their use implies or expresses chronological associations.

### Overview

Before describing the subject matter more fully with reference to the drawings, this section provides an overview of examples of systems and operations for providing enhanced targeting using A/B testing. These examples are useful in providing enhanced targeted advertising using A/B testing that provides a target for targeted advertising that will respond and/or lead to a desired response (such as a conversion) where the largest influence in the desired response is the ad or ad campaign under study. These examples are also useful in providing solutions for many technical problems associated with online targeted advertising.

The example systems and operations can seek to build a pair of differential behavioral data sets similar to an A/B clinical study. Then two or more models can be built on each data set. In an example, these models can be based on machine learning and/or statistical analysis. The differential learning between the two or more models can then be used to enhance predictions of desired response probabilities mostly or only due to the influence of the ad or ad campaign being modeled.

As advertisers increasingly shift towards true campaign lift based models, they will seek more accurate performance reporting and accountability of each ad campaign run by different ad platforms. Collecting all the influence data from all other ad campaigns not controlled by an ad platform is nearly impossible. In other words, the ad platform ends up shooting in the dark and hoping that local enhancement will move a campaign in the right direction. These example systems and operations should turn the current process much more towards scientific learning and enhancement through modeling of A/B testing results. The modeling should turn out to be mathematically aligned to direct ad campaign lift, but also providing valid insights for campaign operators and advertisers regarding the effectiveness of their actual ads and campaign strategies.

The example systems and operations can include arranging a user based A/B bucket test with a small but statistically significant split on the control portion of the test. To minimize the economic impact, the control portion of users can be shown other unrelated ads other that the treatment ads. These examples can also include collecting separate datasets based on predictive models (such as predictive models per resulting data set). For example, a first model of the treatment sample may determine desired response probabilities with the treatment ads or campaign. A second model can determine desired response probabilities without the treatment ads or campaign. Also, a differential probability can be determined between the results of the two example models. For example, a sigmoid function (such as P=sigmoid(P_{first model}−P_{second model})) can be used to determine the differential, wherein the sigmoid function remaps negative numbers to within [0, 1). These aforementioned operations can be repeated iteratively so that the differential can direct targeting and/or ad selection decisions. Also, the P_{first model} and P_{second model} can become more accurate with each of the iterations. It is advantageous to use a randomization function to determine the test and control samples, so that the A/B test is not tainted. These operations if done correctly can enhance net lift in an ad campaign. This can result in every campaign dollar spent on target users and/or situations most likely to be influenced by the ad campaign, instead of targeting ads to users and/or situations likely to cause a desired response regardless of the ad or ad campaign under study. This then translates into much greater efficiency of a treated ad campaign under the enhanced targeted advertising system. These examples can drive true desired response lift due to the sole influence of an ad or ad campaign. This will maximize the use of each ad and ad campaign based on true lift rather than the noisy outcome of consumers being influenced by other ad campaigns, social influence online or offline, or other known influences of desired responses.

### DESCRIPTION OF THE DRAWINGS

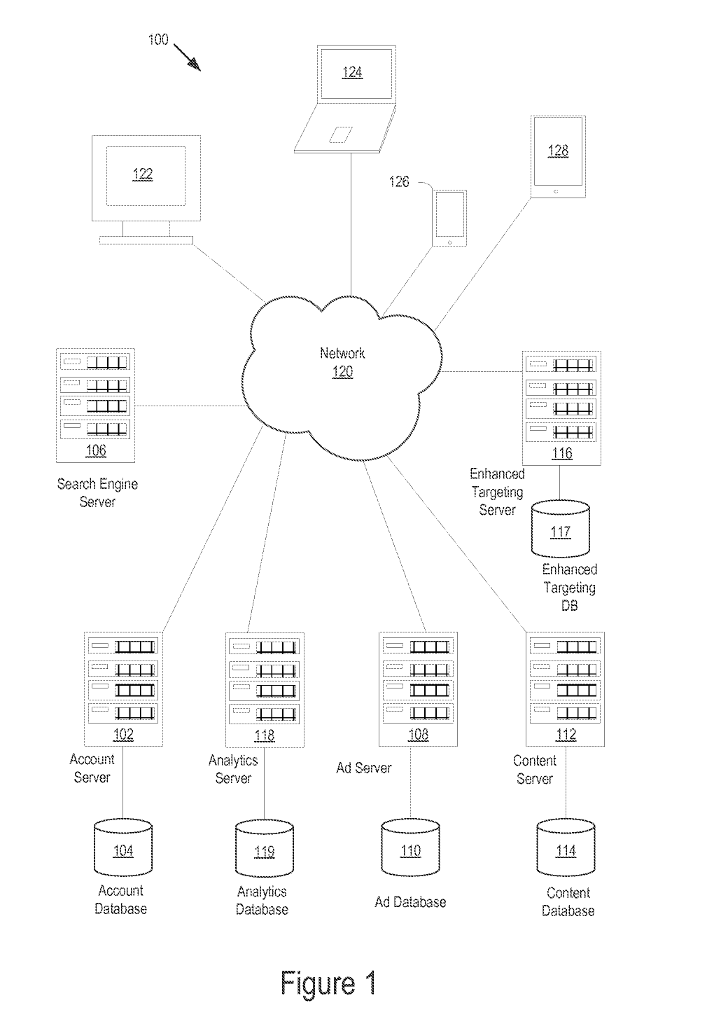

FIG. 1 illustrates a block diagram of an example information system 100 that includes example devices of a network that can communicatively couple with an example system that can provide enhanced targeted advertising using A/B tests. The information system 100 in the example of FIG. 1 includes an account server 102, an account database 104, a search engine server 106, an ad server 108, an ad database 110, a content database 114, a content server 112, an enhanced targeting server 116, an enhanced targeting database 117, an analytics server 118, and an analytics database 119. The aforementioned servers and databases can be communicatively coupled over a network 120. The network 120 may be a computer network. The aforementioned servers may each be one or more server computers.

The information system 100 may be accessible over the network 120 by advertiser devices and audience devices, which may be desktop computers (such as device 122), laptop computers (such as device 124), smartphones (such as device 126), and tablet computers (such as device 128). An audience device can be a user device that presents online advertisements, such as a device that presents online advertisements to an audience member. In various examples of such an online information system, users may search for and obtain content from sources over the network 120, such as obtaining content from the search engine server 106, the ad server 108, the ad database 110, the content server 112, and the content database 114. Advertisers may provide advertisements for placement on online properties, such as web pages, and other communications sent over the network to audience devices. The online information system can be deployed and operated by an online services provider, such as Yahoo! Inc.

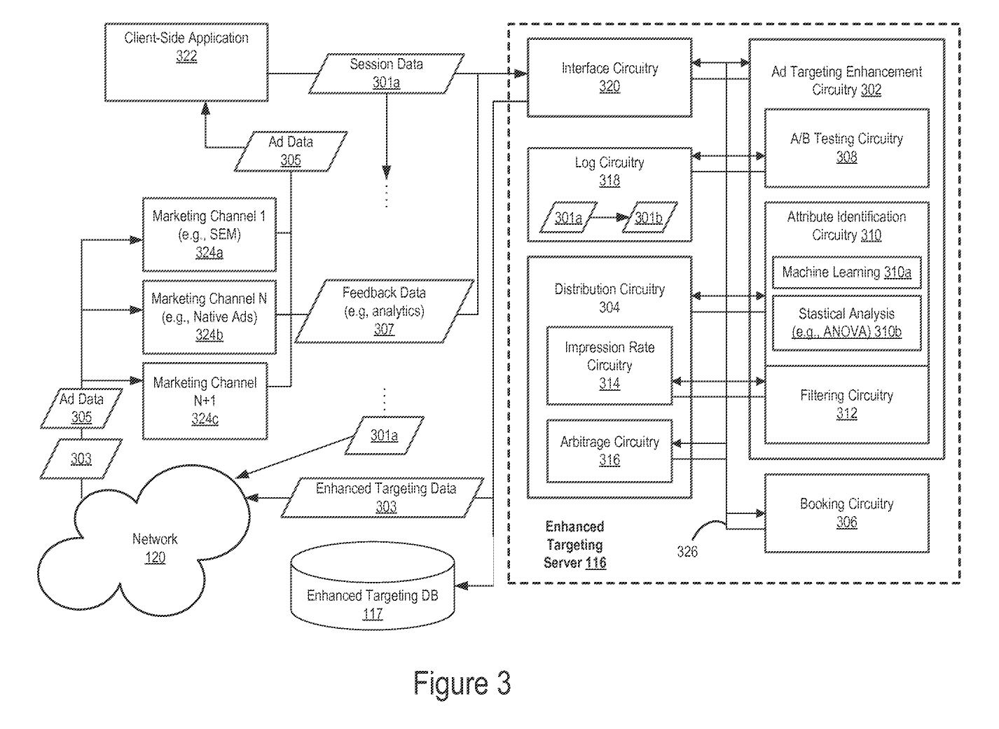

The account server 102 stores account information for advertisers. The account server 102 is in data communication with the account database 104. Account information may include database records associated with each respective advertiser. Suitable information may be stored, maintained, updated and read from the account database 104 by the account server 102. Examples include advertiser identification information, advertiser security information, such as passwords and other security credentials, account balance information, and information related to content associated with their ads, and user interactions associated with their ads and associated content. The account information may include ad booking information, and such booking information may be communicated to the enhanced targeting server 116 for processing. This booking information can be used as input for determining pricing of enhanced targeted impressions, such as the pricing determined by the booking circuitry 306 illustrated in FIG. 3.

The account server 102 may be implemented using a suitable device. The account server 102 may be implemented as a single server, a plurality of servers, or another type of computing device known in the art. Access to the account server 102 can be accomplished through a firewall that protects the account management programs and the account information from external tampering. Additional security may be provided via enhancements to the standard communications protocols, such as Secure HTTP (HTTPS) or the Secure Sockets Layer (SSL). Such security may be applied to any of the servers of FIG. 1, for example.

The account server 102 may provide an advertiser front end to simplify the process of accessing the account information of an advertiser. The advertiser front end may be a program, application, or software routine that forms a user interface. In a particular example, the advertiser front end is accessible as a website with electronic properties that an accessing advertiser may view on an advertiser device, such as one of the devices 122-128 when logged on by an advertiser. The advertiser may view and edit account data and advertisement data, such as ad booking data, using the advertiser front end. After editing the advertising data, the account data may then be saved to the account database 104.

The search engine server 106 may be one or more servers. Alternatively, the search engine server 106 may be a computer program, instructions, or software code stored on a computer-readable storage medium that runs on one or more processors of one or more servers. The search engine server 106 may be accessed by audience devices over the network 120. An audience client device may communicate a user query to the search engine server 106. For example, a query entered into a query entry box can be communicated to the search engine server 106. The search engine server 106 locates matching information using a suitable protocol or algorithm and returns information to the audience client device, such as in the form of ads or content.

The search engine server 106 may be designed to help users and potential audience members find information located on the Internet or an intranet. In an example, the search engine server 106 may also provide to the audience client device over the network 120 an electronic property, such as a web page, with content, including search results, information matching the context of a user inquiry, links to other network destinations, or information and files of information of interest to a user operating the audience client device, as well as a stream or web page of content items and advertisement items selected for display to the user. This information provided by the search engine server 106 may be logged, and such logs may be communicated to the analytics server 118 for processing and analysis. Besides this information, any data outputted by processes of the servers of FIG. 1 may also be logged, and such logs can be communicated to the analytics server 118 for further processing and analysis. The data logs and/or the analytics outputted by the analytics server 118 can be input for the various operations and aspects of the ad targeting enhancement circuitry 302, the distribution circuitry 304, and the booking circuitry 306 illustrated in FIG. 3.

The search engine server 106 may enable a device, such as an advertiser client device or an audience client device, to search for files of interest using a search query. Typically, the search engine server 106 may be accessed by a client device (such as the devices 122-128) via servers or directly over the network 120. The search engine server 106 may include a crawler component, an indexer component, an index storage component, a search component, a ranking component, a cache, a profile storage component, a logon component, a profile builder, and application program interfaces (APIs). The search engine server 106 may be deployed in a distributed manner, such as via a set of distributed servers, for example. Components may be duplicated within a network, such as for redundancy or better access.

The ad server 108 may be one or more servers. Alternatively, the ad server 108 may be a computer program, instructions, and/or software code stored on a computer-readable storage medium that runs on one or more processors of one or more servers. The ad server 108 operates to serve advertisements to audience devices. An advertisement may include text data, graphic data, image data, video data, or audio data. Advertisements may also include data defining advertisement information that may be of interest to a user of an audience device. The advertisements may also include respective audience targeting information and/or ad campaign information, such as some of the enhanced target data illustrated in FIG. 3. An advertisement may further include data defining links to other online properties reachable through the network 120. The aforementioned targeting information and the other data associated with advertising may be logged in data logs. These logs, similar to other data logs described herein, can also be communicated to the analytics server 118 for further processing and analysis. The data logs and/or the analytics outputted by the analytics server 118 can be input for the various operations and aspects of the ad targeting enhancement circuitry 302, the distribution circuitry 304, and/or the booking circuitry 306.

For online service providers, advertisements may be displayed on electronic properties resulting from a user-defined search based, at least in part, upon search terms. Also, advertising may be beneficial and/or relevant to various audiences, which may be grouped by demographic and/or psychographic. A variety of techniques have been developed to determine audience groups and to subsequently target relevant advertising to members of such groups. Group data and individual user's interests and intentions along with targeting data related to campaigns may be may be logged in data logs. As mentioned, one approach to presenting targeted advertisements includes employing demographic characteristics (such as age, income, sex, occupation, etc.) for predicting user behavior, such as by group. Advertisements may be presented to users in a targeted audience based, at least in part, upon predicted user behavior. Another approach includes profile-type ad targeting. In this approach, user profiles specific to a user may be generated to model user behavior, for example, by tracking a user's path through a website or network of sites, and compiling a profile based, at least in part, on pages or advertisements ultimately delivered. A correlation may be identified, such as for user purchases, for example. An identified correlation may be used to target potential purchasers by targeting content or advertisements to particular users. Similarly, the aforementioned profile-type targeting data may be logged in data logs. Yet another approach includes targeting based on content of an electronic property requested by a user. Advertisements may be placed on an electronic property or in association with other content that is related to the subject of the advertisements. The relationship between the content and the advertisement may be determined in a suitable manner. The overall theme of a particular electronic property may be ascertained, for example, by analyzing the content presented therein. Moreover, techniques have been developed for displaying advertisements geared to the particular section of the article currently being viewed by the user. Accordingly, an advertisement may be selected by matching keywords, and/or phrases within the advertisement and the electronic property. The aforementioned targeting data may be logged in data logs.

The ad server 108 includes logic and data operative to format the advertisement data for communication to an audience member device, which may be any of the devices 122-128. The ad server 108 is in data communication with the ad database 110. The ad database 110 stores information, including data defining advertisements, to be served to user devices. This advertisement data may be stored in the ad database 110 by another data processing device or by an advertiser. The advertising data may include data defining advertisement creatives and bid amounts for respective advertisements and/or audience segments. The aforementioned ad formatting and pricing data may be logged in data logs.

The advertising data may be formatted to an advertising item that may be included in a stream of content items and advertising items provided to an audience device. The formatted advertising items can be specified by appearance, size, shape, text formatting, graphics formatting and included information, which may be standardized to provide a consistent look for advertising items in the stream. The aforementioned advertising data may be logged in data logs.

Further, the ad server 108 is in data communication with the network 120. The ad server 108 communicates ad data and other information to devices over the network 120. This information may include advertisement data communicated to an audience device. This information may also include advertisement data and other information communicated with an advertiser device. An advertiser operating an advertiser device may access the ad server 108 over the network to access information, including advertisement data. This access may include developing advertisement creatives, editing advertisement data, deleting advertisement data, setting and adjusting bid amounts and other activities. The ad server 108 then provides the ad items to other network devices, such as the enhanced targeting server 116, the analytics server 118, and/or the account server 102. Ad items and ad information, such as pricing, can be used as input for the various operations and aspects of the ad targeting enhancement circuitry 302, the distribution circuitry 304, and/or the booking circuitry 306.

The ad server 108 may provide an advertiser front end to simplify the process of accessing the advertising data of an advertiser. The advertiser front end may be a program, application or software routine that forms a user interface. In one particular example, the advertiser front end is accessible as a website with electronic properties that an accessing advertiser may view on the advertiser device. The advertiser may view and edit advertising data using the advertiser front end. After editing the advertising data, the advertising data may then be saved to the ad database 110 for subsequent communication in advertisements to an audience device. In viewing and editing the advertising data, adjustments can be used as input for the various operations and aspects of the ad targeting enhancement circuitry 302, the distribution circuitry 304, and/or the booking circuitry 306. The advertiser front end may also provide a graphical user interface for simulating ad campaigns according to operations performed by the enhanced targeting server 116 and associated circuitry (such as the client-side application circuitry 322).

The content server 112 may access information about content items either from the content database 114 or from another location accessible over the network 120. The content server 112 communicates data defining content items and other information to devices over the network 120. The information about content items may also include content data and other information communicated by a content provider operating a content provider device. A content provider operating a content provider device may access the content server 112 over the network 120 to access information. This access may be for developing content items, editing content items, deleting content items, setting and adjusting bid amounts and other activities, such as associating content items with certain types of ad campaigns. A content provider operating a content provider device may also access the enhanced targeting server 116 over the network 120 to access analytics data and controller related data. Such analytics and controller data may help focus developing content items, editing content items, deleting content items, setting and adjusting bid amounts, and activities related to distribution of the content.

The content server 112 may provide a content provider front end to simplify the process of accessing the content data of a content provider. The content provider front end may be a program, application or software routine that forms a user interface. In a particular example, the content provider front end is accessible as a website with electronic properties that an accessing content provider may view on the content provider device. The content provider may view and edit content data using the content provider front end. After editing the content data, such as at the content server 112 or another source of content, the content data may then be saved to the content database 114 for subsequent communication to other devices in the network 120. In editing the content data, adjustments to controller variables and parameters may be determined and presented upon editing of the content data, so that a publisher can view how changes affect pacing of one or more ad campaigns.

The content provider front end may be a client-side application. A script and/or applet and the script and/or applet may manage the retrieval of campaign data. In an example, this front end may include a graphical display of fields for selecting audience segments, segment combinations, or at least parts of campaigns. Then this front end, via the script and/or applet, can request data related to campaign pacing from the enhanced targeting server 116. The information related to campaign pacing can then be displayed, such as displayed according to the script and/or applet.

The content server 112 includes logic and data operative to format content data for communication to the audience device. The content server 112 can provide content items or links to such items to the analytics server 118 or the enhanced targeting server 116 to associate with campaign pacing. For example, content items and links may be matched to such data. The matching may be complex and may be based on historical information related to control of campaigns, such as pacing control of campaigns.

The content data may be formatted to a content item that may be included in a stream of content items and advertisement items provided to an audience device. The formatted content items can be specified by appearance, size, shape, text formatting, graphics formatting and included information, which may be standardized to provide a consistent look for content items in the stream. The formatting of content data and other information and data outputted by the content server may be logged in data logs. For example, content items may have an associated bid amount that may be used for ranking or positioning the content items in a stream of items presented to an audience device. In other examples, the content items do not include a bid amount, or the bid amount is not used for ranking the content items. Such content items may be considered non-revenue generating items. The bid amounts and other related information may be logged in data logs.

The aforementioned servers and databases may be implemented through a computing device. A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

Servers may vary widely in configuration or capabilities, but generally, a server may include a central processing unit and memory. A server may also include a mass storage device, a power supply, wired and wireless network interfaces, input/output interfaces, and/or an operating system, such as Windows Server, Mac OS X, UNIX, Linux, FreeBSD, or the like.

The aforementioned servers and databases may be implemented as online server systems or may be in communication with online server systems. An online server system may include a device that includes a configuration to provide data via a network to another device including in response to received requests for page views or other forms of content delivery. An online server system may, for example, host a site, such as a social networking site, examples of which may include, without limitation, Flicker, Twitter, Facebook, LinkedIn, or a personal user site (such as a blog, vlog, online dating site, etc.). An online server system may also host a variety of other sites, including, but not limited to business sites, educational sites, dictionary sites, encyclopedia sites, wikis, financial sites, government sites, etc.

An online server system may further provide a variety of services that may include web services, third-party services, audio services, video services, email services, instant messaging (IM) services, SMS services, MMS services, FTP services, voice over IP (VOIP) services, calendaring services, photo services, or the like. Examples of content may include text, images, audio, video, or the like, which may be processed in the form of physical signals, such as electrical signals, for example, or may be stored in memory, as physical states, for example. Examples of devices that may operate as an online server system include desktop computers, multiprocessor systems, microprocessor-type or programmable consumer electronics, etc. The online server system may or may not be under common ownership or control with the servers and databases described herein.

The network 120 may include a data communication network or a combination of networks. A network may couple devices so that communications may be exchanged, such as between a server and a client device or other types of devices, including between wireless devices coupled via a wireless network, for example. A network may also include mass storage, such as a network attached storage (NAS), a storage area network (SAN), or other forms of computer or machine readable media, for example. A network may include the Internet, local area networks (LANs), wide area networks (WANs), wire-line type connections, wireless type connections, or any combination thereof. Likewise, sub-networks, such as may employ differing architectures or may be compliant or compatible with differing protocols, may interoperate within a larger network, such as the network 120.

Various types of devices may be made available to provide an interoperable capability for differing architectures or protocols. For example, a router may provide a link between otherwise separate and independent LANs. A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links, including satellite links, or other communication links or channels, such as may be known to those skilled in the art. Furthermore, a computing device or other related electronic devices may be remotely coupled to a network, such as via a telephone line or link, for example.

An advertiser client device, which may be any one of the device 122-128, includes a data processing device that may access the information system 100 over the network 120. The advertiser client device is operative to interact over the network 120 with any of the servers or databases described herein. The advertiser client device may implement a client-side application for viewing electronic properties and submitting user requests. The advertiser client device may communicate data to the information system 100, including data defining electronic properties and other information. The advertiser client device may receive communications from the information system 100, including data defining electronic properties and advertising creatives. The aforementioned interactions and information may be logged in data logs.

In an example, content providers may access the information system 100 with content provider devices that are generally analogous to the advertiser devices in structure and function. The content provider devices provide access to content data in the content database 114, for example.

An audience client device, which may be any of the devices 122-128, includes a data processing device that may access the information system 100 over the network 120. The audience client device is operative to interact over the network 120 with the search engine server 106, the ad server 108, the content server 112, the enhanced targeting server 116, and the analytics server 118. The audience client device may implement a client-side application for viewing electronic content and submitting user requests. A user operating the audience client device may enter a search request and communicate the search request to the information system 100. The search request is processed by the search engine and search results are returned to the audience client device. The aforementioned interactions and information may be logged.

In other examples, a user of the audience client device may request data, such as a page of information from the online information system 100. The data instead may be provided in another environment, such as a native mobile application, TV application, or an audio application. The online information system 100 may provide the data or re-direct the browser to another source of the data. In addition, the ad server may select advertisements from the ad database 110 and include data defining the advertisements in the provided data to the audience client device. The aforementioned interactions and information may be logged in data logs and such logs.

An advertiser client device and an audience client device operate as a client device when accessing information on the information system 100. A client device, such as any of the devices 122-128, may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device, a Personal Digital Assistant (PDA), a handheld computer, a tablet computer, a laptop computer, a set top box, a wearable computer, an integrated device combining various features, such as features of the forgoing devices, or the like.

A client device may vary in terms of capabilities or features. Claimed subject matter is intended to cover a wide range of potential variations. For example, a cell phone may include a numeric keypad or a display of limited functionality, such as a monochrome liquid crystal display (LCD) for displaying text. In contrast, however, as another example, a web-enabled client device may include a physical or virtual keyboard, mass storage, an accelerometer, a gyroscope, global positioning system (GPS) or other location-identifying type capability, or a display with a high degree of functionality, such as a touch-sensitive color 2D or 3D display, for example.

A client device may include or may execute a variety of operating systems, including a personal computer operating system, such as a Windows, iOS or Linux, or a mobile operating system, such as iOS, Android, or Windows Mobile, or the like. A client device may include or may execute a variety of possible applications, such as a client software application enabling communication with other devices, such as communicating messages, such as via email, short message service (SMS), or multimedia message service (MMS), including via a network, such as a social network, including, for example, Facebook, LinkedIn, Twitter, Flickr, or Google+, to provide only a few possible examples. A client device may also include or execute an application to communicate content, such as, for example, textual content, multimedia content, or the like. A client device may also include or execute an application to perform a variety of possible tasks, such as browsing, searching, playing various forms of content, including locally or remotely stored or streamed video, or games. The foregoing is provided to illustrate that claimed subject matter is intended to include a wide range of possible features or capabilities. At least some of the features, capabilities, and interactions with the aforementioned may be logged in data logs.

Also, the disclosed methods and systems may be implemented at least partially in a cloud-computing environment, at least partially in a server, at least partially in a client device, or in a combination thereof.

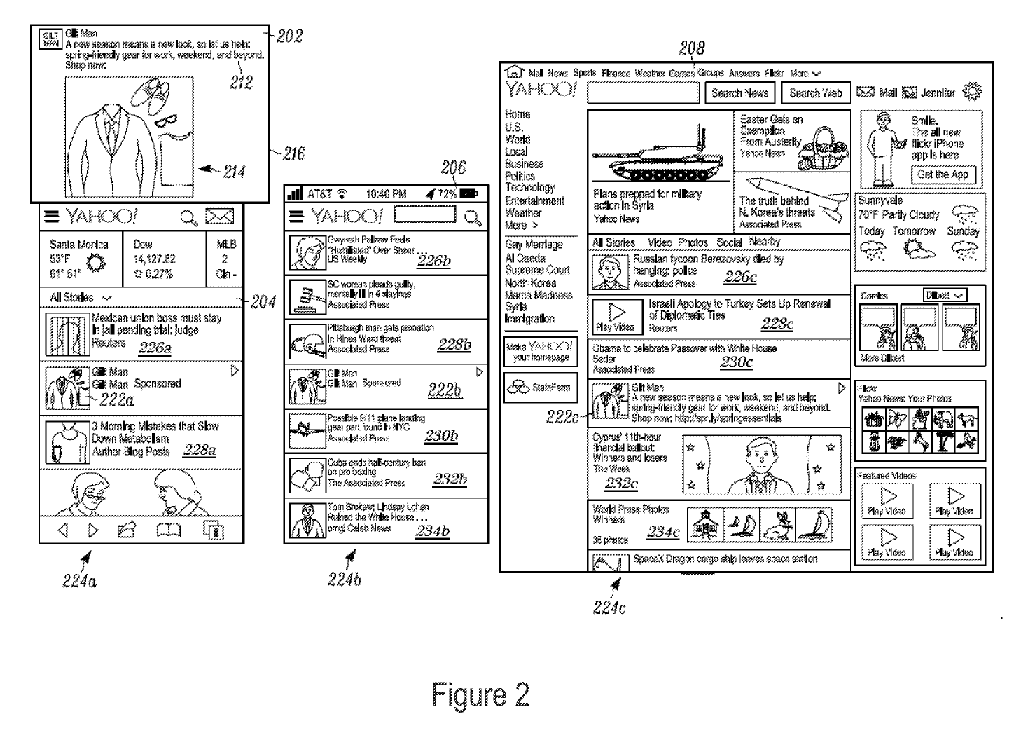

FIG. 2 illustrates displayed ad items and content items of example screens rendered by client-side applications. The content items and ad items displayed may be provided by the search engine server 106, the ad server 108, or the content server 112. User interactions with the ad items and content items can be tracked and logged in data logs, and the logs may be communicated to the analytics server 118 for processing. Once processed into corresponding analytics data, the analytics data can be input for the various operations and aspects of the ad targeting enhancement circuitry 302, the distribution circuitry 304, and/or the booking circuitry 306, which are illustrated in FIG. 3. Also, session data including indications of the user interactions with the items (such as session data 301a) may be directly communicated to the interface circuitry 320 and then identified and logged by the log circuitry 318 illustrated in FIG. 3. The result of these operations of the log circuitry 318 may result in the user interaction information 301b. The part of the user interaction information 301b can be used in the A/B tests. The data logs and/or the analytics outputted by the analytics server 118 and the log circuitry 318 can be input for the various operations and aspects of the ad targeting enhancement circuitry 302, the distribution circuitry 304, and/or the booking circuitry 306.

In FIG. 2, a display ad 202 is illustrated as displayed on a variety of displays including a mobile web device display 204, a mobile application display 206 and a personal computer display 208. The mobile web device display 204 may be shown on the display screen of a smart phone, such as the device 126. The mobile application display 206 may be shown on the display screen of a tablet computer, such as the device 128. The personal computer display 208 may be displayed on the display screen of a personal computer (PC), such as the desktop computer 122 or the laptop computer 124.

The display ad 202 is shown in FIG. 2 formatted for display on an audience device but not as part of a stream to illustrate an example of the contents of such a display ad. The display ad 202 includes text 212, graphic images 214 and a defined boundary 216. The display ad 202 can be developed by an advertiser for placement on an electronic property, such as a web page, sent to an audience device operated by a user. The display ad 202 may be placed in a wide variety of locations on the electronic property. The defined boundary 216 and the shape of the display ad can be matched to a space available on an electronic property. If the space available has the wrong shape or size, the display ad 202 may not be useable. Such reformatting may be logged in data logs and such logs may be communicated to the analytics server 118 for processing. The data logs and/or the processed analytics can be input for the various operations and aspects of the ad targeting enhancement circuitry 302, the distribution circuitry 304, and/or the booking circuitry 306.

In these examples, the display ad is shown as a part of streams 224a, 224b, and 224c. The streams 224a, 224b, and 224c include a sequence of items displayed, one item after another, for example, down an electronic property viewed on the mobile web device display 204, the mobile application display 206 and the personal computer display 208. The streams 224a, 224b, and 224c may include various types of items. In the illustrated example, the streams 224a, 224b, and 224c include content items and advertising items. For example, stream 224a includes content items 226a and 228a along with advertising item 222a; stream 224b includes content items 226b, 228b, 230b, 232b, 234b and advertising item 222b; and stream 224c includes content items 226c, 228c, 230c, 232c and 234c and advertising item 222c. With respect to FIG. 2, the content items can be items published by non-advertisers. However, these content items may include advertising components. Each of the streams 224a, 224b, and 224c may include a number of content items and advertising items.

In an example, the streams 224a, 224b, and 224c may be arranged to appear to the user to be an endless sequence of items, so that as a user, of an audience device on which one of the streams 224a, 224b, or 224c is displayed, scrolls the display, a seemingly endless sequence of items appears in the displayed stream. The scrolling can occur via the scroll bars, for example, or by other known manipulations, such as a user dragging his or her finger downward or upward over a touch screen displaying the streams 224a, 224b, or 224c. To enhance the apparent endless sequence of items so that the items display quicker from manipulations by the user, the items can be cached by a local cache and/or a remote cache associated with the client-side application or the page view. Such interactions may be communicated to the analytics server 118. The corresponding analytics outputted by the analytics server 118 can be input for the various operations and aspects of the ad targeting enhancement circuitry 302, the distribution circuitry 304, and/or the booking circuitry 306.

The content items positioned in any of streams 224a, 224b, and 224c may include news items, business-related items, sports-related items, etc. Further, in addition to textual or graphical content, the content items of a stream may include other data as well, such as audio and video data or applications. Each content item may include text, graphics, other data, and a link to additional information. Clicking or otherwise selecting the link re-directs the browser on the client device to an electronic property referred to as a landing page that contains the additional information. The clicking or otherwise selecting of the link, the re-direction to the landing page, the landing page, and the additional information, for example, can each be tracked, and then the data associated with the tracking can be logged in data logs, and such logs may be communicated to the analytics server 118 for processing. The data logs and/or the analytics outputted by the analytics server 118 can be input for the various operations and aspects of the ad targeting enhancement circuitry 302, the distribution circuitry 304, and/or the booking circuitry 306.

Stream ads like the advertising items 222a, 222b, and 222c may be inserted into the stream of content, supplementing the sequence of related items, providing a more seamless experience for end users. Similar to content items, the advertising items may include textual or graphical content as well as other data, such as audio and video data or applications. Each advertising item 222a, 222b, and 222c may include text, graphics, other data, and a link to additional information. Clicking or otherwise selecting the link re-directs the browser on the client device to an electronic property referred to as a landing page. The clicking or otherwise selecting of the link, the re-direction to the landing page, the landing page, and the additional information, for example, can each be tracked, and then the data associated with the tracking can be logged in data logs, and such logs may be communicated to the analytics server 118 for processing. The data logs and/or the analytics outputted by the analytics server 118 can be input for the various operations and aspects of the ad targeting enhancement circuitry 302, the distribution circuitry 304, and/or the booking circuitry 306.

While the example streams 224a, 224b, and 224c are shown with a single visible advertising item 222a, 222b, and 222c, respectively, a number of advertising items may be included in a stream of items. Also, the advertising items may be slotted within the content, such as slotted the same for all users or slotted based on personalization or grouping, such as grouping by audience members or content. Adjustments of the slotting may be according to various dimensions and algorithms. Also, slotting may be according to campaign control.

The slotting and any other operation associated with campaign control described herein may occur via controller interface circuitry that provides interfacing between a controller and other types of circuits, such as a circuit of any of the servers illustrated in FIG. 1. The controller interface circuitry and the controller may be hosted on the enhanced targeting server 116.

FIG. 3 illustrates a block diagram of example aspects of a system, such as the system in FIG. 1, which can provide enhanced targeted advertising using A/B tests. Each of the circuitries may be hosted by one or more servers, such as one or more of the servers illustrated in FIG. 1. For example, many of the circuitries may be embedded in the enhanced targeting server 116. The circuitries in FIG. 3 include ad targeting enhancement circuitry 302, distribution circuitry 304, booking circuitry 306, A/B testing circuitry 308 (which can run A/B tests and includes circuitry for storing inputs of the A/B tests such as sampling groups, a treatment ad, and a control ad and outputs such as information pertaining discovered targets), attribute identification circuitry 310 (which includes machine learning circuitry 310a and statistical analysis circuitry 310b), filtering circuitry 312, impression rate circuitry 314, arbitrage circuitry 316, log circuitry 318, interface circuitry 320, client-side application circuitry 322, and marketing channel circuitries 324a-324c. Each of the circuitries can be communicatively coupled with each other. For example, the circuitries 302-320 may be communicatively coupled via a bus 326. Also, these circuitries and the bus may be part of the enhanced targeting server 116, for example. Also, these circuitries may be communicatively coupled with other circuitries and/or themselves over a network, such as network 120 illustrated in FIG. 1. For example, circuitries of the enhanced targeting server 116 may be communicatively coupled to the client-side application circuitry 322 and the marketing channel circuitries 324a-324c over the network 120. The client-side application circuitry 322 may be a part of any one of the client devices 122-128 illustrated in FIG. 1. The marketing channel circuitries 324a-324c each may be part of any one or more of the servers illustrated in FIG. 1. Additionally or alternatively, the circuitries 302-320 may be part of any one or more of the servers illustrated in FIG. 1.

FIG. 3 illustrates the enhanced targeting server 116 receiving session data 301a via its interface circuitry 320. The session data 301a may be communicated from the client-side application circuitry 322. In an example, the session data 301a may include corresponding device data, user profile data, raw user interaction data, and application specific session data associated with the client-side application run by the client-side application circuitry 322. The session data 301a may be received by the interface circuitry 320 directly from the client-side application circuitry over the network 120 or from data logs received by the interface circuitry over the network, such as analytics sent from the analytics server 118.

The interface circuitry 320 may also output enhanced targeting data 303, which may be communicated to the enhanced targeting database 117 or over the network 120 and to servers hosting the marketing channels, such as channels 324a-324c. Also, through the network 120, such as by the ad server 108, ad data 305 along with the enhanced targeting data 303 may be communicated to the marketing channels and back to the client-side application circuitry 322.

The client-side application circuitry 322 may use the ad data 305 and the enhanced targeting data 303 to render corresponding enhanced targeting. The marking channels may use the enhanced targeting data 303 to direct the use of the ad data 305 by the client-side application circuitry 322. For example, at a server of a marketing channel, circuitry of the channel may filter the ad data 305 according to the enhanced targeting data 303. This filtered ad data may then be used to render impressions accordingly.

Further, analytics, raw and processed user interaction data, ad targeting and/or retargeting data, ad data, or any combination thereof may be communicated back to the enhanced targeting server 116 via the interface circuitry 320, such as in the form of feedback data 307. The feedback data 307 may enhance the operations of the ad targeting enhancement circuitry 302, the distribution circuitry 304, the booking circuitry 306, and/or the log circuitry 318. Also, as depicted in FIG. 3, each circuitry of the enhanced targeting server 116 can provide input and feedback to the other circuitries of the enhanced targeting server, and to other parts of the system such as any one or more of the servers illustrated in FIG. 1 (such as through the network 120). The enhanced targeting data 303 may include data corresponding to output of any one of the circuitries of the enhanced targeting server 116 (such as respective outputs of the circuitries 302-306, which can include respective outputs of circuitries 308-316).

In an example, a webpage can provide a search tool, a content stream (such as where selecting an item in the stream results in an online presentation of corresponding content), and other sources of online generated revenue, such as advertisements served through native ad marking channels. For examples of such items, see FIG. 2 and the corresponding description. In FIG. 3, the marketing channels 324a-324c may each include one or more of these technologies and sources of revenue. In such examples, tracking of enhanced targeting may be incorporated with the webpage or a collection of related webpages including the aforementioned elements. In another example, the content provider providing content listed in the depicted webpage also can provide the search engine services and the marketing channel services from any parts of the system illustrated in FIGS. 1 and 3. Additionally or alternatively, the system of these Figures may exchange information with other information systems, such as other systems providing one or more of content, advertising services, and online searching technologies. These other systems may include cloud computing systems and social media systems (such as an online social networking service). Also, in these examples, tracking of enhanced targeting may be incorporated.

The enhanced targeting server 116 includes the interface circuitry 320, which can be configured to receive session data 301a, such as browser and user session data associated with a web browser session. The session data 301a can include information regarding tracked enhanced targeting. The enhanced targeting server 116 can also include log circuitry 318 that can be configured to generate user interaction logs (including logs of user interactions associated with enhanced targeting) according to the session data 301a. Additionally or alternatively, the session data 301a can be provided by any one or more of the servers illustrated in FIG. 1, such as the analytics server 118, the content server 112, and the ad server 108, such as in the form of data logs. In such examples, user interaction information may be provided directly from such servers so that the information bypasses further processing by the log circuitry 318.

In an example, user interaction information can be derived from application data such as session data. The application data can include or be HTTP session data, data from the application layer of a system under the OSI model or a similar networking or internetworking model, and/or application data from an application not using networking. The application data can include data associated or included in a communication of an email, an online search (such as information pertaining to a submitted search query), and online commercial transactions (such as online purchases).

The user interactions can be anonymized, sortable, filtered, normalized, or any combination thereof. Anonymity can occur via unique identifications per user so that actual users exist but they are anonymized. The identifications can be randomly generated or arbitrarily generated codes. The log circuitry 318 can perform these actions on the user interaction information. Also, the log circuitry 318 can transform application data (such as the session data 301a) to the user interaction information (such as user interaction information 301b).

The user interaction information can include a first set of user interactions associated with a treatment ad inputted into an A/B test ran by the A/B testing circuitry 308. The user interaction information can also include a second set of the user interactions associated with a control ad inputted into the test. The user interactions can include clicks on the treatment ad and the control ad. The user interactions can also include online conversion events associated with the treatment ad and the control ad, such as associated votes, purchases, subscriptions, posts, or any combination thereof. The clicks and/or the conversion events can be made by a first sample of online audience members belonging to the treatment of the A/B test. The clicks and/or the conversion events can also be made by a second sample of online audience members belonging to the control of the A/B test. These clicks and/or conversion events occur within a given time period of the A/B test. The first sample, the second sample, and the given time period are inputs of the A/B test. To clarify, the user interaction information associated with the A/B test is actually the output resulting from the A/B test. This output provides information pertaining to the sought after target of the A/B test. As explained herein, the A/B test can be rerun with refined inputs according to feedback (such as the feedback data 307), and as a result of the rerun test, the target can become more refined as well.

The first and second samples of online audience members (i.e., the treatment and control samples) can include the same online audience members. These samples can also include similar online audience members in which the similarities are pre-defined. For example the two sample may be similar in that both samples are generated randomly or using a same or similar criteria.

Regarding the goal of the A/B test, the treatment ad can include an ad that the advertiser is interested in delivering to a target that is discovered through the A/B test. In other words, the goal of the A/B test is to determine the target. The target can include a target ad spot for the treatment ad (such as a particular ad spot on a particular web property or a mobile application), a target ad spot type for the treatment ad (such as banner ad spot, a banner ad spot on a particular type of web property or mobile application, etc.), a target audience group for the treatment ad, a target online audience member to target, or any combination thereof. A target audience group can be grouped by a demographic (such as sex, gender, age, residence, place of birth, ethnicity, religion, or any combination thereof) and/or a psychographic (such as gender, preferences, behaviors, intents, life stage, lifestyle, or any combination thereof). Preferences can include a preference for certain online content, a preference for a device for browsing online (such as a certain brand or type of device such as a mobile device, desktop computer, etc.), a preference for a web browser, a temporal preference (such as a preference for browsing on a certain day of the week, a certain hour of the day, a certain time of the year, etc.), or any combination thereof. A target online audience member can have a certain user profile. Such a profile can include a combination of demographics, psychographics that define a certain online user. The user profile can be a profile of an actual user and that actual user can have a certain status, such as a status of using the Internet or a certain Internet property or mobile application over a predefined threshold. In other words, the goal of the A/B test is to determine a target group of users and/or a target scenario/context for the treatment ad.

The control ad can be the control of the A/B test and/or the primary parameter that differentiates the control from the treatment of the A/B test. Also, the treatment ad can be the primary parameter of the treatment. In other words, that can be one or more treatments and controls per A/B test. The control ad can be randomly selected by the A/B testing circuitry and the selection can be completely independent of prior tests or the treatment. Alternatively, the control ad can be randomly selected but according to criteria, so not completely random. In such an example, in rerunning the A/B test, both the control and the treatment samples and the control ad can be refined to enhance the information resulting from the A/B test (i.e., enhance or refine the target). Also, the refining of the samples of the A/B tests can act as a differentiator between the treatment and control and/or iterations of the A/B test.

In an example, the treatment ad can be one ad of a group of treatment ads of a treatment of an A/B test. Also, the control ad can be one ad of a group of control ads of a control of the A/B test. In such an example, the group of control ads can be derived from random selection of ads and/or according to criteria.

The ad targeting enhancement circuitry 302 can include the A/B testing circuitry 308, the attribute identification circuitry 310, and the filtering circuitry 312. The attribute identification circuitry 310 can include machine learning circuitry 310a and statistical analysis circuitry 310b. The A/B testing circuitry 308 can run the A/B tests described herein. The A/B testing circuitry 308. As depicted in FIG. 3, in an example, the attribute identification circuitry 310 can be tightly coupled to the filtering circuitry 312. For example, these circuitries can be comingled so that sub-processes/calculations performed by the attribute identification circuitry 310 and the filtering circuitry 312 can be interdependent seamlessly without extraneous communications to bridge these two circuitries.

In an example, the attribute identification circuitry 310 can be configured to identify a first attribute of the first sample of online audience members (i.e., the treatment sample) that correlate to the first set of user interactions. The attribute identification circuitry 310 can alternatively be configured to identify a first set of attributes of the first sample of online audience members that correlate to the first set of user interactions. The attribute identification circuitry 310 can also be configured to identify a second attribute (or alternatively a second set of attributes) of the second sample of online audience members (i.e., the control sample) that correlate to the second set of user interactions.

The first and second attributes (or the first and second sets of attributes) can include identified ad spots (such as a particular ad spot on a particular web property or a mobile application), identified ad spot types (such as video ad spots, native ad spots, banner ad spots, ad spots on a particular type of web property or mobile application, etc.), identified user preferences (such as a user's product preferences), identified user interests, identified user intents, identified online audiences (such as identified by demographic and/or psychographic), identified contextual attributes (such as identified times of day, daily activities, locations, points of interest, etc.), or any combination thereof.

The attribute identification circuitry 310 can be configured to identify the first and second attributes (or the first and second sets of attributes) by respective temporal information occurring in or associated with the user interaction information. The respective temporal information can provide a respect link for each of the first and second attributes (or the first and second sets of attributes) to the first and second sets of user interactions, respectively.

Additionally or alternatively, the attribute identification circuitry 310 machine learning] can be configured to identify the first and second attributes (or the first and second sets of attributes) by respective arrangements (such as respective data sorts) of the user interaction information by respective criteria. From the respective arrangements, the attribute identification circuitry 310 can identify respective groupings of data in the respective organized user interaction information. In an example configuration, the first and second attributes (or the first and second sets of attributes) can correspond to respective largest groupings of data in the respective arrangements of the user interaction information. For example, one arrangement of the user interaction information belonging to the treatment samples can include data sorted by attributes and the grouping of attributes that belong to the largest grouping in the arrangement can be identified as the first attribute or the first set of attributes.

Additionally or alternatively, the attribute identification circuitry 310 can be configured to identify the first attribute (or the first set of attributes) by a correlation with the first set of user interactions that is greater than a first correlation threshold. The attribute identification circuitry 310 can also be configured to identify the second attribute (or the second set of attributes) by a correlation with the second set of user interactions that is greater than a second correlation threshold. These and other thresholds may be adjusted through the modeling process to enhance discoveries made through the A/B tests ran by the A/B testing circuitry 308. Also, the first, second, and additional correlation thresholds may be the same value to maintain consistency or modularity in the system.

Identification of an attribute or sets of attributes may not be exclusive and such an identification within the user interaction information may include identifications of combined attributes combined through various types of associations, such as co-occurrence associations, repetitive patterns of co-occurrences, patterns indicative of iterative refinement (such as in a sequence of online search queries), temporal associations, or any combination thereof.

In an example, one or more of the circuitries of the ad targeting enhancement circuitry 302 can determine a first probability defining influence of the treatment ad(s) on a desired response (such as a conversion) associated with the first attribute or sets of attributes. The first probability can be denoted by P_{first model}. The one or more of the circuitries of the ad targeting enhancement circuitry 302 can also determine a second probability defining influence of the control ad(s) on a desired response (such as a conversion) associated with the second attribute or sets of attributes. The second probability can be denoted by P_{second model}. Upon such determinations, the ad targeting enhancement circuitry 302 can also determine a probability differential denoted by P, wherein one example P=sigmoid(P_{first model}−P_{second model}). The probability differential can indicate an amount of influence of the treatment ad or set of ads on the target.

The correlations and arrangements in the user interaction information can be provided by the machine learning circuitry 310a and/or the statistical analysis circuitry 310b. Also, the first and second probabilities and the probability differential P can be determined by the machine learning circuitry 310a and/or the statistical analysis circuitry 310b. The machine learning circuitry 310a can be configured to run machine learning processes and the statistical analysis circuitry 310b can be configured to run statistical analysis such as analysis of variance (ANOVA). In other words, machine learning processes and/or a machine operated statistical analysis (such as regression analysis and ANOVA) can be applied to variables of the user interaction information, by the respective circuitries of the attribute identification circuitry 310, to estimate various relationships among the variables. One or more of these relationships may be used by these circuitries to identify an attribute or set of attributes associated with or correlated to a desired user interaction with or associated with online advertising (such as any of the attributes or sets of attributes described herein). In the case of the regression analysis, such an analysis can include analyzing the variables to find a relationship between a dependent variable and one or more independent variables in the user interaction information. The dependent variable may include input criteria of the treatment and the control, and the predicted output may include a predicted target that is a prediction of the target. Additionally or alternatively, the output may include a probability of the predicted target that can include a probability of an occurrence of the predicted target. These probabilities and predictions can then be used to determine the respective influences of the treatment and control ads on desired responses associated with the first and second attribute or sets of attributes. Finally, the probability differential can be determined, which provides an indication of an amount of influence of the treatment ad or set of ads on the target.

Machine learning can include an algorithm or generation/modification of an algorithm through an automation process of implemented by a machine that can learn from data such as data inputted in to the machine from processes independent of the machine and/or from feedback from processes not independent of the machine. The inputs are used to make predictions or decisions, rather than the machine following only explicitly programmed instructions. Approaches to machine learning can include, decision tree learning, association rule learning, artificial neural networks, inductive logic programming, support vector machines, clustering, Bayesian networks, reinforcement learning, representation learning, similarity and metric learning, sparse dictionary learning, or any known and/or foreseeable combinations thereof. The output of machine learning may be used by the attribute identification circuitry 310 to identify an attribute or set of attributes associated with or correlated to a desired user interaction with or associated with online advertising (such as any of the attributes or sets of attributes described herein). The machine learning can also be used to determine the respective influences of the treatment and control ads on desired responses associated with the first and second attribute or sets of attributes. Finally, the probability differential can be determined, which provides an indication of an amount of influence of the treatment ad or set of ads on the target.

In an example, the filtering circuitry 312 can be configured to filter the user interaction information to exclude, at least in part, indications of user interactions associated with the first attribute of the first sample (or the first set of attributes of the first sample). The filtering circuitry 312 can also be configured to filter the user interaction information to exclude, at least in part, indications of user interactions associated with the second attribute of the second sample (or the second set of attributes of the second sample). These filtering processes can be varied, such as by various degrees, by the attribution identification circuitry 310 and/or the filtering circuitry 312. The degree of filtering across several attributes may be constant. This can improve modularity of the system in that filtering parameters can be adjusted for many attributes using one configuration instead of many separate configurations. Alternatively, filtering variations per attribute may be different and/or independent of other filtering variations for other attributes. In another example, the variations of filtering per attribute may vary but be dependent and/or related to filtering configures of other attributes. Any of these options may be combined in the filtering processes described herein.

The filtering processes may also be adjusted (such as per attribute or group of attributes) through a modeling process ran by the attribute identification circuitry 310 and/or the filtering circuitry 312. The modeling process may include machine learning (which is run by the machine learning circuitry 310a) and/or machine operated statistical analysis (which is run by the statistical analysis circuitry 310b). The modeling process may enhance the analysis of the output of the A/B tests. As a result, the modeling may enhance the effectiveness of identifying the target through the user interaction information. Also, the modeling processes can provide an indication of an amount of influence of the treatment ad or set of ads on the target. Such an indication can be based on the outputs associated with the identification of the target.

In one example, the modeling process may include analysis through a Taylor series analytic function. For example, Formula 1 may be used as a basis for the analytic function.

$${\sum }_{n = 0}^{∞} \frac{{\int }^{( n )} ( a )}{n !} {( x - a )}^{n} , \qquad ( 1 )$$

where n! denotes a factorial of n and f⁽ⁿ⁾(a) denotes an nth derivative of f at a point a. A first adjustment of one the filtering processes may include or be associated with a first term of a Taylor series (e.g., f(a)). A second adjustment of that filtering process or a single adjustment of another filtering process may include or be associated with a second term of a Taylor series

$$( e . g . , \frac{{f}^{′} ( a )}{1 !} ( x - a ) ) .$$

A third adjustment of the adjusted filtering process or a single adjustment of another filtering process may include or be associated with a third term of a Taylor series

$$( e . g . , \frac{{f}^{″} ( a )}{2 !} {( x - a )}^{2} ) ,$$

and so on. Finally, such examples of analysis through Taylor series functions can provide input in determining the respective influences of the treatment and control ads on desired responses associated with the first and second attribute or sets of attributes. Finally, the probability differential can be determined, which provides an indication of an amount of influence of the treatment ad or set of ads on the target.

Adjustments to filtering may also be according to Analysis of Variance (ANOVA). The statistical analysis circuitry 310b may run ANOVA tasks and use such tasks to analyze the differences between the attributes and/or sets of attributes identified in the outputs of the A/B tests. ANOVA can analyze differences in group averages (such as differences in means, modes, and medians) of the identified attributes and their associated procedures. Using ANOVA, identified variance in a particular variable can be partitioned into components associated with different sources of variation. ANOVA tests can also identify statistical degrees of similarity between the attributes and the sets of attributes associated with the samples of the A/B tests. Such results can be used to aggregate groups of the attributes and the sets of attributes to reduce processing in seeking out the target. Finally, these groups and/or other findings from the ANOVA tasks can be input in determining the respective influences of the treatment and control ads on desired responses associated with the first and second attribute or sets of attributes. Finally, the probability differential can be determined, which provides an indication of an amount of influence of the treatment ad or set of ads on the target.

In an example, an output of an A/B test can provide a target for the treatment ad through simple analysis. By identifying attributes of the output and then further filtering those attributes, the system can identify a more refined target. As mentioned herein, the filtering processes can be refined by adjustments to the filtering processes described herein and/or through repeated cycles and refinements of the A/B tests and the identifications of the attributes of the A/B tests' samples.

In examples with A/B test output refinement or without such refinement, the interface circuitry 320 can be configured to communicate the treatment advertisement to online audience members. With refinement, the communication of the treatment advertisement is according to a refined target. Without refinement, the communication of the treatment ad is according to a less refined target. The treatment ad can initially be distributed to audience members according to an unprocessed output of a corresponding A/B test. Then feedback (such as the feedback data 307) from such a distribution and/or other factors described herein can influence refinement of the output of a second corresponding A/B test. Such refinement, which may use feedback (such as the feedback data 307) and/or attribute filtering, can reoccur for many steps and should increase the effectiveness of distributing the treatment ad to targets with each reiteration. Also, the repetitions can occur subsequent to reoccurrences of the A/B test, where even the treatment and control samples can be refined according to filtered user interaction information (such as according to once-filtered, twice-filtered, thrice-filtered information, and so on). In alternative examples, the treatment and control samples may remain constant and/or only one A/B test is ran and refinement occurs solely through post A/B test processes, such as the identifying of the relevant attributes of the samples and filtering of those attributes.

In one example, the operations of the attribute identification circuitry 310 may further include identifying third attributes of the first sample (i.e., the treatment sample) that correlate to a third set of user interactions associated with the treatment ad (or a set of treatment ads). The operations may also include identifying fourth attributes of the second sample (i.e., the control sample) that correlate to a fourth set of user interactions associated with the control ad (or set of control ads). In such an example, the attribute identification circuitry 310 may be further configured to identify a third attribute (or a third set of attributes) of the third attributes that correlates to the third set of user interactions greater than a third threshold. Also, the attribute identification circuitry 310 may identify a fourth attribute (or a fourth set of attributes) of the fourth attributes, that matches the third attribute to a pre-defined extent. In such an example, the filtering circuitry 312 may be configured to filter (such as for a second time) the user interaction information to exclude indications of user interactions associated with the third attribute (or with the third set of attributes). The filtering may be done to a third degree, for example. The filtering circuitry 312 may also filter (such as for a second time) the user interaction information to exclude indications of user interactions associated with the fourth attribute (or with the fourth set of attributes) to a fourth degree. In an example, the interface circuitry may communicate the advertisement to the online audience members according to the first and/or the second once-filtered user interaction information, the first and/or the second twice-filtered information, or any combination thereof.

Resulting from the example operations described herein (such as resulting from the operations performed by the A/B testing circuitry 308, the attribute identification circuitry 310, and the filtering circuitry 312), the processed user interaction information may include an indication of the target. In an example, each iteration of refinement (whether it occurs with the same signals or updated versions of the signals from a later time of sampling) enhances/fine tunes the eventual output so that it indicates one or more of online audience member(s) and/or situation(s) that strongly correlate with desired interactions with or associated with a treatment ad.

The ad targeting enhancement circuitry 302 can be configured to determine a target audience and/or online situation at various levels of granularity, for a given ad (such as the treatment ad or an ad with a pre-defined amount of similarity to the treatment ad). The ad targeting enhancement circuitry 302 can include A/B testing circuitry 308 configured to identify the effect of the treatment ad on audience samples according to one or more A/B tests. The effect of the treatment ad on audience samples can be identified according to a comparison to results between a sample tested with a control ad or control set of ads and a sample tested with the treatment ad or treatment set of ads. The various circuitries of the attribute identification circuitry 310 and the filtering circuitry 312 can then determine attributes of the treatment and control samples that possible influence and/or at least explain the effect of the treatment ad on the samples. The attributes can be discovered at varying degrees of refinement. Finally, the refined attributes provide a more refined target.

The target can include a page parameter, an ad spot parameter, and/or a user parameter. Such components of the target can be outputted to other parts of the system in the enhanced targeting data 303. The page parameter can include subject matter of a page, graphical features of the page, dimensions of the page, viewable portions of the page, visibility rates of the portions or the whole page, rate of impressions on the page, and temporal information regarding any one or more of the aforementioned parameters. The ad spot parameter can include subject matter of an ad spot, dimensions of the spot, viewable portions of the spot, visibility rates of the portions or the whole spot, rate of impressions on the spot, and temporal information regarding any one or more of the aforementioned parameters. The user parameter can include a demographic of the user (e.g., age, sex, residence, and birthplace), a psychographic of the user (e.g., online behavior such as average dwell time, common online queries, and rates of certain queries), a geographic location of the user, and temporal information regarding any one or more of the aforementioned parameters or any combination thereof.

Also, the ad targeting enhancement circuitry 302 can be configured to repeat the determination of the target and the enhanced targeting data 303. With such repetition the accuracy of P=sigmoid(P_{first model}−P_{second model}) can be increased by increasing the accuracy of the target indicated via the P_{first model} and the P_{second model}. Such repetitions may be further enhanced by the feedback data 307, which may include analytics from the analytics server 118.

Also, according to the feedback data and/or the session data 301a/user interaction information 301b, the distribution circuitry 304 can be configured to control an impression rate of the treatment ad (or treatment set of ads). The distribution circuitry 304 can also be configured to distribute impressions of the treatment ad (or treatment set of ads) according to the impression rate. Initially or in conjunction with the control of the impression rate, the impression rate circuitry 314 can determine the impression rate of the treatment ad(s). The determination of the impression rate of the treatment ad(s) can vary per identified/filtered attribute discovered by the attribute identification circuitry 310 and/or the filtering circuitry 312. The impression rate of the treatment ad(s) can also vary per target discovered by the ad targeting enhancement circuitry 302. Finally, the impression rates determined by the impression rate circuitry 314 can be included in the enhanced targeting data 303.

The distribution circuitry 304 can also be further configured to control an impression rate of a second ad or set of ads according to a likeness score indicating the relative likeness between treatment ad(s) and the second ad(s). In an example, the likeness score can be determined using a Gaussian function and parameters of the ads as input to the function. In such an example, the distribution circuitry 304 can distribute impressions of the second ad(s) using impression rates (such as rates per target) for the treatment ad(s), when the likeness score exceeds a likeness threshold. Therefore, the operations of the ad enhancement circuitry 302 do not have to be rerun for the second ad(s), saving processing, storage, caching, and network communication resources.

The booking circuitry 306 can be configured to price an impression of the treatment ad(s) or the second ad(s) according information outputted by the ad targeting enhancement circuitry 302 and/or the distribution circuitry 304. Also, the distribution circuitry 304 can adjust its determinations according to outputs of the booking circuitry 306 and/or the ad targeting enhancement circuitry 302. The booking circuitry 306 can also price an impression of second ad(s) according to information on the treatment ad(s) when the likeness score exceeds a threshold. This can be done on a per target basis. In such an example, the booking circuitry can determines whether the second ad(s) are relatively comparable to the treatment ad(s) by determining a likeness score, such as through a Gaussian function. Where the likeness score for the ads exceeds a likeness threshold, the ads are identified to be relatively comparable. Therefore, if the threshold is exceeded, then booking circuitry 306 can price impressions of the second ad(s) according to the pricing of the treatment ad(s), such as with respect to targets.

Additionally, the ad targeting enhancement circuitry 302, the distribution circuitry 304, and the booking circuitry 306 can be configured to repeat their operations at commencement of different time periods of online ad campaigns corresponding to the treatment ad(s). The repeated operations can be according to feedback from prior time periods, which results in updated outputs of these circuitries and therefore updated versions of the enhanced targeting data 303. Additionally, the ad targeting enhancement circuitry 302 can be configured to repeat the operations of the circuitries 302-306 according to a likeness score indicating a likeness between multiple ad campaigns that include the treatment ad(s) and/or the second ad(s). Such a likeness score may be determined according to a Gaussian function. For example, a second campaign can be controlled according to enhanced targeting data associated with a first campaign, where the likeness score for the campaigns exceeds a likeness threshold. Beneficial to such an example, the distribution circuitry 304 can also include the arbitrage circuitry 316 that can be configured to perform an arbitrage between the first and second campaigns based on the various impression rates for the campaigns and/or the likeness score.

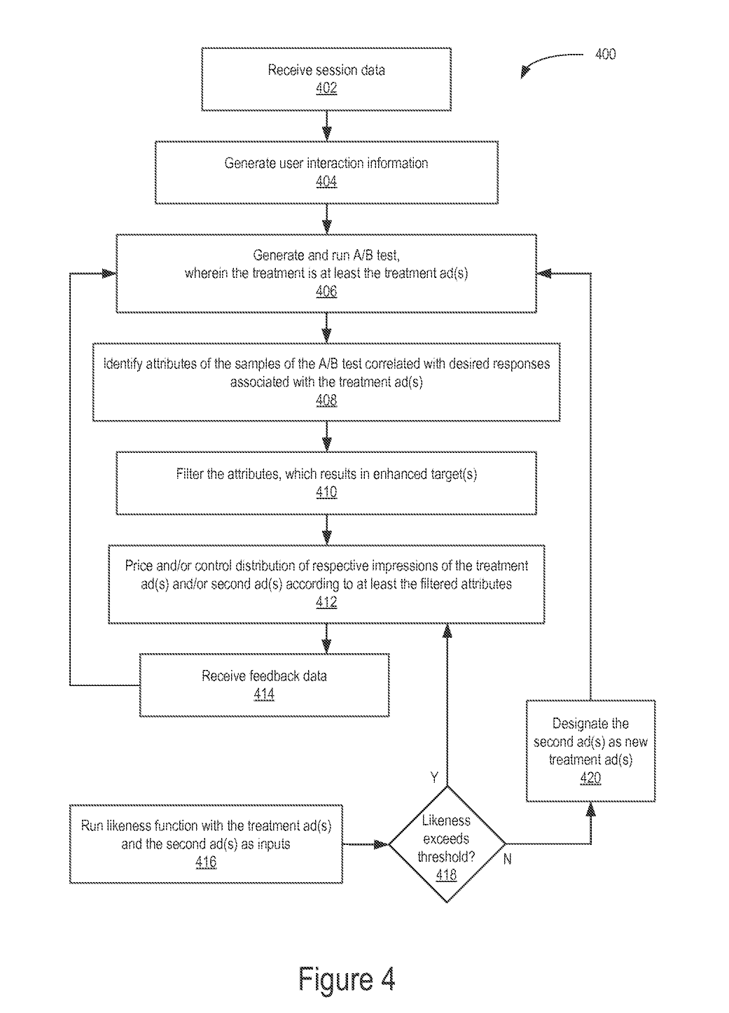

FIG. 4 illustrates example operations 400 performed by a system, such as one of the systems illustrated in FIGS. 1 and 3. The example operations 400 provide enhanced targeted advertising according to A/B testing and analysis/filtering of the A/B testing results. For example, a system such as the system of the enhanced targeting server 116 can include circuitry (such as the interface circuitry 320) that can receive session data (such as session data 301a) at 402. The system can also include circuitry (such as the log circuitry 318) that can convert the session data into user interaction logs at 404. The user interaction logs can include the user interaction information (such as user interaction information 301b). The enhanced targeting server 116 can also include circuitry (such as the A/B testing circuitry 308) to generate and run an A/B test on a part of the user interaction information at 406. The A/B test may include a treatment sample and a control sample, as discussed herein. The treatment used in the running of the test at 406 is at last a treatment ad or a set of treatment ads. The samples, the treatment, and the control can all be derived from the user interaction information. Results of the running of the test at 406 can occur from a linking of the information associated with the samples, the treatment, and the control for a specified time period. This information may be historical with respect to generation of the A/B test or may be a result of actions that occurred subsequent to generation of the A/B test and the information is fed to the test in real time.

At 408, circuitry of the system (such as the attribute identification circuitry 310 and/or any one or more of its sub-circuitries) identifies attributes of the samples of the A/B test correlated with desired responses associated the treatment ad(s) and/or control ad(s). The desired responses can include any desired action associated with one of the treatment and/or control ad(s). For example, desired responses can be corresponding ad impressions, viewable impressions, complete views of ads in video(s), ad clicks, purchases or other types of desired transactions linked to the ads, or any combination thereof. The attributes can be any of the attributes of samples described herein. The attributes can also be identified by determinations of the desired response probabilities P_{first model} and P_{second model} and the probability differential P. For example, attributes with a higher probability differential P are more indicative of a worthwhile target. Also, the attributes can be described by any of the various types of information and/or functions for identifying attributes described herein.

At 410, circuitry of the system (such as the filtering circuitry 312 and/or the attribute identification circuitry 310 and/or any one or more of its sub-circuitries) filters the attributes according to any of the various types of information and/or functions for filtering described herein. For example, filtering can occur according a respective probability differential P of an attribute or set of attributes. At 412, circuitry of the system (such as the booking circuitry 306 and distribution circuitry 304) prices impressions of the treatment ad(s) and/or controls distribution of the impressions according to at least the filtered attributes. Upon distribution of the impressions of the treatment ad(s), new session data may be generated associated with the impressions. At 414, feedback (which may include the new session data and/or analytics from another source such as the analytics server 118) is received at the circuitry that can receive session data. This circuitry may also receive corresponding analytics from the analytics server 118.

At 416, circuitry of the system (such as the distribution circuitry 304 or the booking circuitry 306) can run a likeness function that determines the likeness between the treatment ad(s) and a second ad or second set of ads. The likeness function can determine the likeness according to a Gaussian function using parameters of the treatment ad(s) and the second ad(s) as input. At 418, circuitry, such as the circuitry used at 416, can determine whether the likeness exceeds a corresponding likeness threshold. If the threshold is exceeded, circuitry of the system (such as the booking circuitry 306 and distribution circuitry 304) prices impressions of the second ad(s) and/or controls distribution of these impressions according to at least the filtered attributes for the treatment ad(s) instead of analogous attributes for the second ad(s). If the threshold is not exceeded, the second ad(s) are designated by circuitry of the system (such as the ad targeting enhancement circuitry 302) as the new treatment ad(s) at 420. After this designation, operations 406-414 can be repeated for the new treatment ad(s).

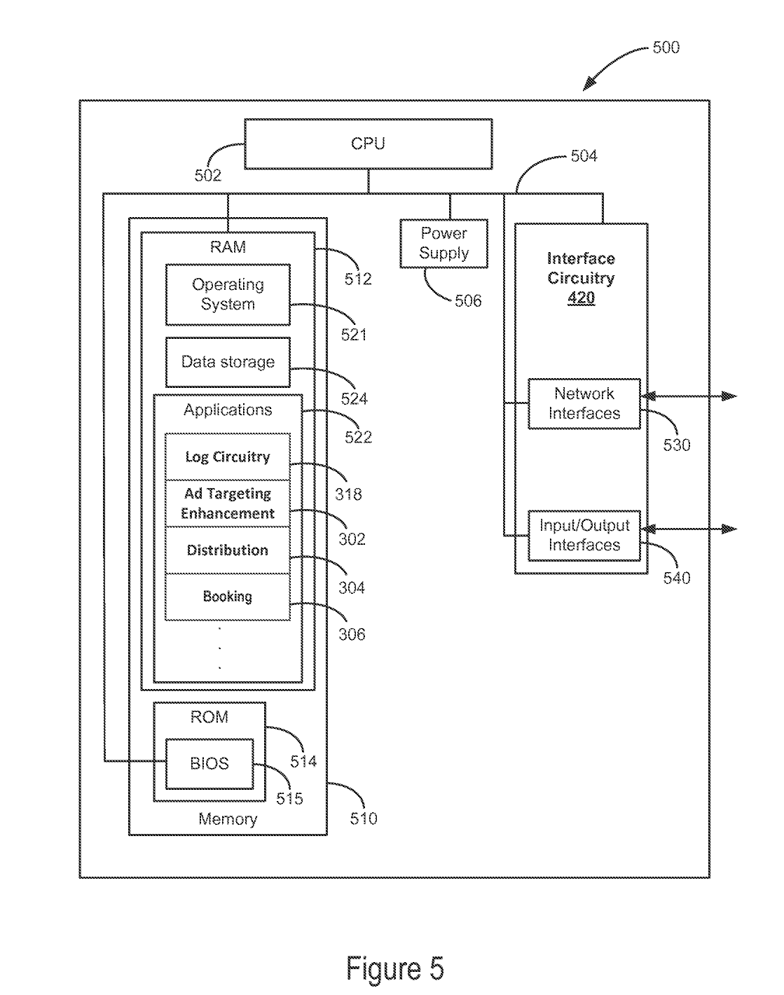

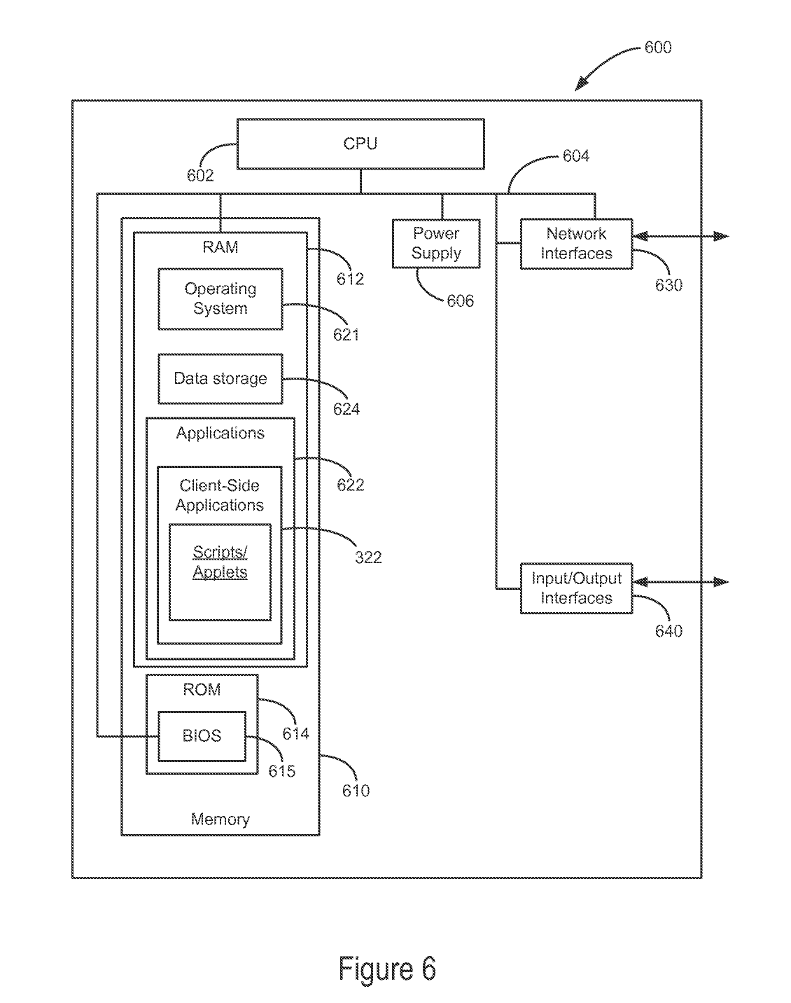

FIGS. 5 and 6 are block diagrams of example electronic devices that can implement aspects of and related to example systems that can provide enhanced targeted advertising using A/B tests. FIG. 6 illustrates a server, such as the enhanced targeting server 116. FIG. 7 illustrates a client device, such as any one of the client devices 122-128 illustrated in FIG. 1 or a device that hosts the client-side application circuitry 322 illustrated in FIG. 3.

The electronic device 500 can include a CPU 502, memory 510, a power supply 506, and input/output components, such as network interfaces 530 and input/output interfaces 540, and a communication bus 504 that connects the aforementioned elements of the electronic device. The network interfaces 530 can include a receiver and a transmitter (or a transceiver), and an antenna for wireless communications. The network interfaces 530 can also include at least part of the interface circuitry 320 illustrated in FIG. 3. The CPU 502 can be any type of data processing device, such as a central processing unit (CPU). Also, for example, the CPU 502 can be central processing logic.

The memory 510, which can include random access memory (RAM) 512 or read-only memory (ROM) 514, can be enabled by memory devices. The RAM 512 can store data and instructions defining an operating system 521, data storage 524, and applications 522, such as applications implemented through hardware including the ad targeting enhancement circuitry 302, the distribution circuitry 304, the booking circuitry 306, and the log circuitry 318. The applications 522 may include hardware (such as circuitry and/or microprocessors), firmware, software, or any combination thereof. The ROM 514 can include basic input/output system (BIOS) 515 of the electronic device 500. The memory 510 may include a non-transitory medium executable by the CPU.

The power supply 506 contains power components, and facilitates supply and management of power to the electronic device 500. The input/output components can include at least part of the interface circuitry 320 for facilitating communication between any components of the electronic device 500, components of external devices (such as components of other devices of the information system 100), and end users. For example, such components can include a network card that is an integration of a receiver, a transmitter, and I/O interfaces, such as input/output interfaces 540. The I/O components, such as I/O interfaces 540, can include user interfaces such as monitors, keyboards, touchscreens, microphones, and speakers. Further, some of the I/O components, such as I/O interfaces 540, and the bus 504 can facilitate communication between components of the electronic device 500, and can ease processing performed by the CPU 502.

The electronic device 500 can send and receive signals, such as via a wired or wireless network, or may be capable of processing or storing signals, such as in memory as physical memory states, and may, therefore, operate as a server. The device 500 can include a single server, dedicated rack-mounted servers, desktop computers, laptop computers, set top boxes, integrated devices combining various features, such as two or more features of the foregoing devices, or the like.

The electronic device 600 can include a central processing unit (CPU) 602, memory 610, a power supply 606, and input/output components, such as network interfaces 630 and input/output interfaces 640, and a communication bus 604 that connects the aforementioned elements of the electronic device. The network interfaces 630 can include a receiver and a transmitter (or a transceiver), and an antenna for wireless communications. The CPU 602 can be any type of data processing device, such as a central processing unit (CPU). Also, for example, the CPU 602 can be central processing logic; central processing logic may include hardware (such as circuitry and/or microprocessors), firmware, software and/or combinations of each to perform functions or actions, and/or to cause a function or action from another component. Also, central processing logic may include a software controlled microprocessor, discrete logic such as an application specific integrated circuit (ASIC), a programmable/programmed logic device, memory device containing instructions, or the like, or combinational logic embodied in hardware. Also, logic may also be fully embodied as software.

The memory 610, which can include random access memory (RAM) 612 or read-only memory (ROM) 614, can be enabled by memory devices, such as a primary (directly accessible by the CPU) and/or a secondary (indirectly accessible by the CPU) storage device (such as flash memory, magnetic disk, optical disk). The memory 610 may include a non-transitory medium executable by the CPU.

The RAM 612 can store data and instructions defining an operating system 621, data storage 624, and applications 622, including the client-side application circuitry 322 illustrated FIG. 3. The applications 622 may include hardware (such as circuitry and/or microprocessors), firmware, software, or any combination thereof. Example content provided by an application, such as the client-side application circuitry 322, may include text, images, audio, video, or the like, which may be processed in the form of physical signals, such as electrical signals, for example, or may be stored in memory, as physical states, for example.

The ROM 614 can include basic input/output system (BIOS) 615 of the electronic device 600. The power supply 606 contains power components, and facilitates supply and management of power to the electronic device 600. The input/output components can include various types of interfaces for facilitating communication between components of the electronic device 600, components of external devices (such as components of other devices of the information system 100), and end users. For example, such components can include a network card that is an integration of a receiver, a transmitter, and I/O interfaces, such as input/output interfaces 640. A network card, for example, can facilitate wired or wireless communication with other devices of a network. In cases of wireless communication, an antenna can facilitate such communication. The I/O components, such as I/O interfaces 640, can include user interfaces such as monitors, keyboards, touchscreens, microphones, and speakers. Further, some of the I/O components, such as I/O interfaces 640, and the bus 604 can facilitate communication between components of the electronic device 600, and can ease processing performed by the CPU 602.

1. A system for providing enhanced targeting of online advertising, comprising:
A/B testing circuitry configured to run an A/B test for a time period, the A/B test including:
user interaction information as input, the input including: a treatment sample of users, a control sample of users, a treatment including a treatment ad, and a control including a control ad; and
resulting output, the output including: a treatment output including indications of desired responses associated with the treatment ad, and a control output including indications of desired responses associated with the control ad;
attribute identification circuitry configured to:
identify attributes of the treatment sample in the treatment output correlated with desired responses associated with the treatment ad; and
identify attributes of the control sample in the control output correlated with desired responses associated with the control ad; and
distribution circuitry configured to control distribution of impressions of the treatment ad over the Internet according to the identified attributes of the treatment and control samples.

2. The system of claim 1, further comprising filtering circuitry configured to filter the identified attributes, resulting in refined attributes.

3. The system of claim 2, wherein the filtering circuitry is further configured to filter the identified attributes according to a Taylor series function.

4. The system of claim 2, wherein the distribution circuitry is further configured to control distribution of the impressions of the treatment ad according the refined attributes.

5. The system of claim 2, further comprising booking circuitry configured to price the impressions of the treatment ad according to the refined attributes.

6. The system of claim 5, wherein the distribution circuitry is further configured to control distribution of the impressions of the treatment ad according to the pricings of the impressions.

7. The system of claim 5, wherein the distribution circuitry is further configured to control impression rates of the impressions of the treatment ad according to the refined attributes.

8. The system of claim 1, wherein the distribution circuitry is further configured to control impression rates of the impressions of the treatment ad according to the identified attributes of the treatment and control samples.

9. The system of claim 1, wherein the A/B testing circuitry is further configured to generate the A/B test.

10. The system of claim 1, wherein the attribute identification circuitry is further configured to identify the attributes of the samples according to machine learning.

11. The system of claim 1, wherein the attribute identification circuitry is further configured to identify the attributes of the samples according to statistical analysis.

12. The system of claim 11, wherein the statistical analysis includes analysis of variance (ANOVA).

13. A system for providing enhanced targeting of online advertising, comprising:
A/B testing circuitry configured to run an A/B test for a time period, the A/B test including:
user interaction information as input, the input including: a treatment sample of users, a control sample of users, a treatment including a treatment ad, and a control including a control ad; and
resulting output, the output including: a treatment output including indications of desired responses associated with the treatment ad, and a control output including indications of desired responses associated with the control ad;
attribute identification circuitry configured to:
identify an attribute of the treatment sample in the treatment output correlated with desired responses associated with the treatment ad;
determine a first probability of the desired responses associated with the treatment ad and the attribute according to the treatment output;
determine a second probability of the desired responses associated with the control ad and the attribute according to the control output; and
determine a probability differential according the first and second probabilities; and
distribution circuitry configured to control impression rates of the treatment ad over the Internet according to the probability differential.

14. The system of claim 13, wherein the attribute identification circuitry is further configured to determine the probability differential according to a sigmoid function of a difference between the first and second probabilities.

15. The system of claim 13, further comprising filtering circuitry configured to filter the determinations of the first and second probabilities, resulting in refined first and second probabilities, and wherein the attribute identification circuitry is further configured to determine the probability differential according to the refined first and second probabilities.

16. The system of claim 15, wherein the filtering circuitry is further configured to filter the determinations of the first and second probabilities according to a Taylor series function.

17. The system of claim 15, wherein the distribution circuitry is further configured to control impression rates of the treatment ad according the refined first and second probabilities.

18. The system of claim 13, wherein the attribute identification circuitry is further configured to determine the first and second probabilities according to machine learning.

19. The system of claim 13, wherein the attribute identification circuitry is further configured to determine the first and second probabilities according to analysis of variance (ANOVA).

20. A method for providing enhanced targeting of online advertising, comprising:
receiving session data over the Internet;
converting the session data into user interaction logs, the logs including user interaction information;
generating and running an A/B test for a time period, the A/B test including:
at least part of the user interaction information as input, the input including: a treatment sample of users, a control sample of users, a treatment including a treatment ad, and a control including a control ad; and
resulting output, the output including: a treatment output including indications of desired responses associated with the treatment ad, and a control output including indications of desired responses associated with the control ad;
identifying an attribute of the treatment sample in the treatment output correlated with desired responses associated with the treatment ad;
determining a first probability of the desired responses associated with the treatment ad and the attribute according to the treatment output;
determining a second probability of the desired responses associated with the control ad and the attribute according to the control output;
determining a probability differential according to a sigmoid function of a difference between the first and second probabilities; and
controlling online distribution of the treatment ad over the Internet according to the probability differential.
